(19) United States
(12) Patent Application Publication
(10) Pub. No.: US 2017/0031177 A1
(43) Pub. Date: Feb. 2, 2017

(54) EYEGLASS FRAME HAVING SELECTIVELY INTERCHANGEABLE TEMPLES WITH SIMPLIFIED RECESSED INTERCONNECTION CLIPS

(71) Applicant: Sean Thomas Bingham, Provo, UT (US)

(72) Inventor: Sean Thomas Bingham, Provo, UT (US)

(21) Appl. No.: 14/811,837

(22) Filed: Jul. 29, 2015

(51) Int. Cl. G02C 5/14

(52) U.S. Cl. CPC G02C 5/146; G02C 2200/08

(57) ABSTRACT

An eyeglass frame having selectively interchangeable temples has a conventional frame front, combined with specially-designed hinges and the temples. Each temple has a longitudinal cavity of generally rectangular cross section, at the hinge end thereof, that is in communication with a rectangular aperture that opens to the inner surface of the temple. Each temple is attached to a frame front end piece via an interconnection clip having a single loop that is sandwiched between two loops that are unitary with the frame front, and with the three loops being held together with a pivot screw, thereby forming a butt hinge. Each interconnection clip incorporates a single-barb spring clip that slides into the longitudinal cavity of a temple. The barb locks against a forward edge of the rectangular aperture. By depressing the barb with a finger, the temple and the interconnection clip can be pulled apart.

### FIELD OF THE INVENTION

This invention relates to eyeglass frames having selectably interchangeable temples.

### BACKGROUND OF THE INVENTION

A standard eyeglass frame includes: a frame front that holds the lenses in place and bridges the top of the nose, the frame front having end pieces that extend from opposite sides of the frame; temples, which are parts of the frame that extend over the ears or over and behind the ears and help hold the frame in place on the wearer's face; and a pair of hinges, each hinge interconnecting an end piece with a temple piece.

Eyeglass frames with temples, the configuration, color or design of which can be changed, are well known in the art. U.S. Pat. No. 5,321,442 (1994) to Albanese, entitled Eyeglasses with Detachable Lenses, Sidebars, and Adjustable Earpieces for example, discloses glasses with sidepieces that are removable including a sleeve which can be snapped onto or slipped from temple piece. Other concepts for the provision of an eyeglass or sunglass frame system with selectably changeable temples are taught in U.S. Pat. No. 3,582,192 (1971) to Gitlin, titled Detachable Decorative Sleeves for Spectacles; U.S. Pat. No. 5,185,620 (1993) to Cooper, titled Eyeglass System; U.S. Pat. No. 5,652,635 (1997) to Kirschner, titled Decorative Sunglasses; U.S. Pat. No. 8,469,508 to Silver, et al., titled Decorative Selectable Arms With Bayonet Clip Attachment of Arms to Eyeglass Frames; and U.S. Pat. No. 8,317,318 to Silver, titled Side Arm Release System for Eyeglass Frame with Changeable Temple Pieces. Such art is also disclosed in PCT Publication WO/2009/052705 to Smart Vision Limited, entitled Glass Structure for Changeable Temple Sleeves.

The two heretofore referenced Silver patents, which have been assigned to Silver Global Manufacturing LLC, disclose the use of a double-pronged bayonet clip to anchor the temples to the frame front. Because the a double-pronged male bayonet clip was chosen, a mating female socket must protrude from each of the temples so that the double-pronged male bayonet clip can be compressed with the thumb and forefinger in order to release the interconnection clip. The Silver '318 Patent adds a feature whereby a user can decouple the clips by rotating the temples beyond their normal rotational limits.

### SUMMARY OF THE INVENTION

The present invention provides an eyeglass frame having selectively interchangeable temples with simplified interconnection clips that are not only easier to disconnect and reconnect, but because they are recessed within the temples, are far less bulky than those of the referenced Silver patents, and provide enhanced safety for the wearer in the event that an object, such as a volleyball, were to impact a corner of the eyeglass frame and force the interconnection clip toward the wearer's face or eye. Because the interconnection clip of the referenced Silver patents protrudes from the temples of the frame, a user's face—or even eyeball—could be injured or cut by the abrupt edges of the interconnection clip. The interconnection feature of the present invention eliminates that risk.

To a casual observer, the eyeglass frame of the present invention appear to be conventional. Though the frame front is conventional, the hinges and the temples are not. For the present invention, each temple has a longitudinal cavity of generally rectangular cross section at the hinge end thereof. The cavity of each temple is in communication with a rectangular aperture that opens to the inner surface (the surface adjacent the head of a wearer) of the temple. For a presently preferred embodiment of the invention, each temple is attached to a frame front end piece via an interconnection clip having a single loop that is sandwiched between two loops that are unitary with the frame front, with the three loops being held together with a pivot screw, thereby forming a butt hinge. Each interconnection clip incorporates a single-barb spring clip that slides into the longitudinal cavity of a temple. The barb of the spring clip compresses as it enters the longitudinal cavity, then expands as it reaches the rectangular aperture, thereby locking the spring clip inside the longitudinal cavity. By depressing the barb with a finger, the temple and the interconnection clip can be pulled apart. A semi-cylindrical recess below rectangular aperture, on the inner surface of the temple, facilitates depressing the barb with the end of a finger. With a modicum of practice, the temples can be changed within ten seconds.

### BRIEF DESCRIPTION OF THE DRAWINGS

FIG. 1 is a bottom plan view of the eyeglass frame having temples that can be removed and replaced within ten seconds;

FIG. 2 is a front elevational view of the eyeglass frame of FIG. 1;

FIG. 3 is a left-side elevational view of the eyeglass frame of FIG. 1;

FIG. 4 is an elevational view of the inside of the left temple;

FIG. 5 is a front elevational view of the left temple;

FIG. 6 is a side elevational view of the left frame front and the single loop butt hinge installed between the two loops of the left frame front end piece and with a self-tapping screw ready for installation within the hinge pivot apertures;

FIG. 7 is an elevational view of the outside of a single loop butt hinge and single-barb clip;

FIG. 8 is an elevational view of the inside of the single loop butt hinge and single-barb clip of FIG. 7;

FIG. 9 is a top plan view of the single loop butt hinge and single-barb clip of FIG. 7;

FIG. 10 is a front elevational view of the single loop butt hinge and single-barb clip of FIG. 7;

FIG. 11 is a rear elevational view of the single loop butt hinge and single-barb clip of FIG. 7;

FIG. 12 is an inside elevational view of the front end of the left temple and of the single loop butt hinge and single-barb clip, which is about to be inserted into the rectangular aperture of the left temple; and

FIG. 13 is an inside elevational view of the front end of the left temple with the single loop butt hinge and single-barb clip installed therein.

### PREFERRED EMBODIMENT OF THE INVENTION

The new Eyeglass Frame Having Selectively Interchangeable Temples with Simplified Recessed Interconnection Clips will now be described in detail with reference to the attached drawing figures. It should be understood that the drawings may not necessarily be drawn to scale and are intended to be merely illustrative of the invention.

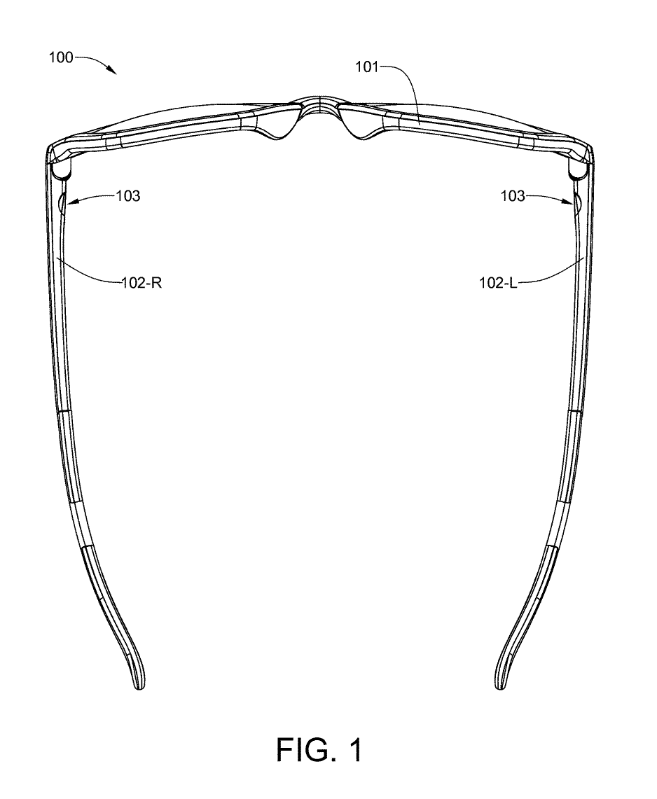

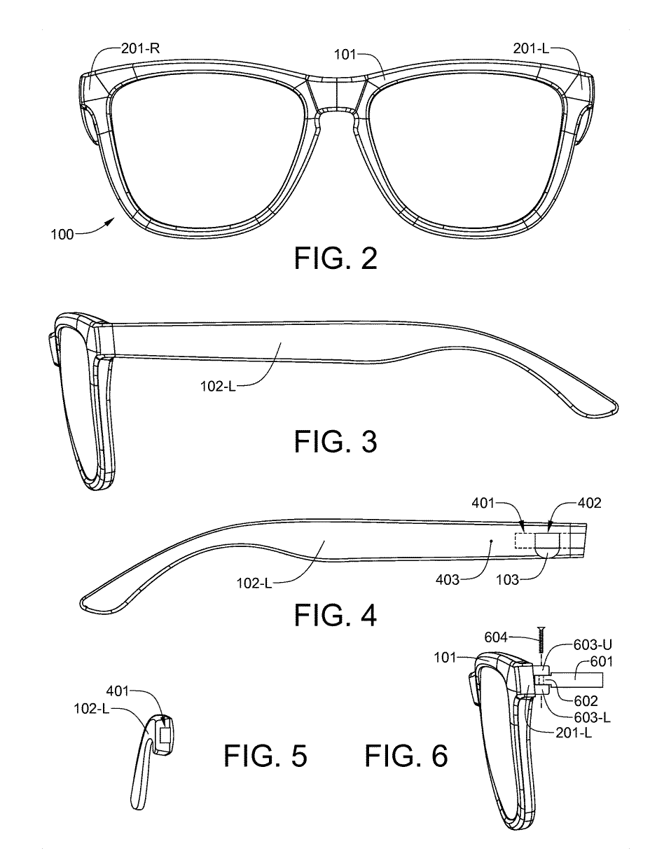

Referring now to FIGS. 1, 2 and 3, to a casual observer, the eyeglass frame 100 of the present invention appear to be conventional. However, though the frame front 101 and left and right frame front end pieces 201-L and 201-R, respectively, are conventional, the hinges (not visible in these views) and the temples 102-L and 102-R are not. The only hint of non-conventionality is the presence of a semi-cylindrical recess 103 on each temple 102-L and 102-R, which are visible in FIG. 1.

Referring now to FIGS. 4 and 5, each temple 102-L and 102-R (which is a mirror image of temple 102-L) has a longitudinal cavity 401 of generally rectangular cross section at the hinge end thereof. The cavity 401 of each temple is in communication with a rectangular aperture 402 that opens to the inner surface 403 (the surface adjacent the head of a wearer) of the temple 102-L and 102-R.

Referring now to FIG. 6, each frame front end piece 201-L and 201-R (not shown in this view, but 201-R a mirror image of frame front end piece 201-L) is attached to an interconnection clip 601, respectively, via a butt hinge. Each interconnection clip 601 is integral with a single hinge loop 602 that is sandwiched between an upper hinge loop 603-U and a lower hinge loop 603-L, both of which are coaxial and unitary with the frame front 101 and left end piece 201-L (the right end piece 201-R and its two integral hinge loops are a mirror image of left end piece 201-L and its two integral hinge loops). A screw 604, which axially interconnects the single loop 602 to the two loops 603-U and 603-L on the left end piece 201-L, provides the pivot axis for the butt hinge. The right end piece

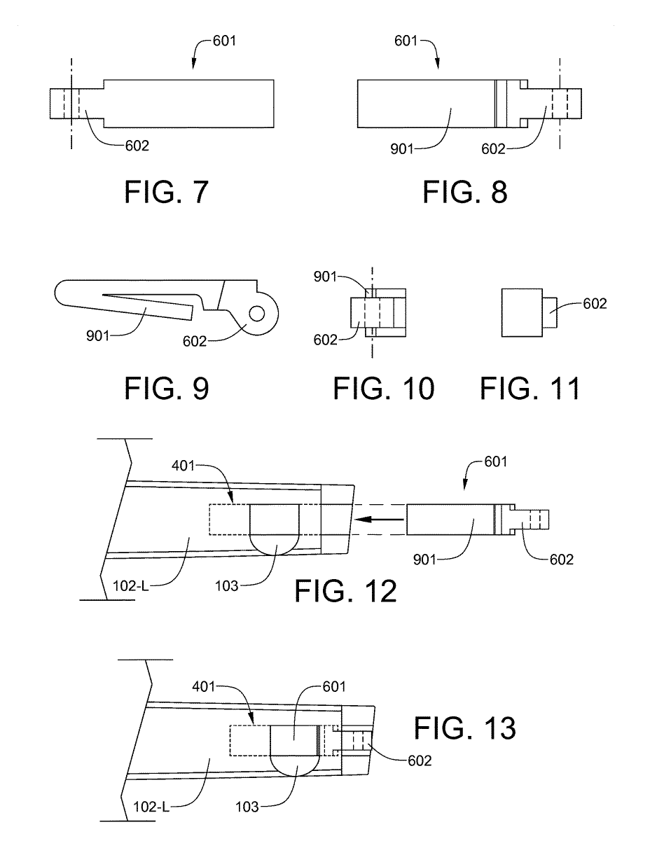

Referring now to FIGS. 7 to 11, each interconnection clip 601 incorporates a single resilient barb 701. The barb end 702 of the interconnection clip 601 slides into the longitudinal cavity 401 of a temple 102-L or 102-R. The barb 901 of the interconnection clip 601 compresses as it enters the longitudinal cavity 401, then expands as it reaches the rectangular aperture 402, thereby locking the interconnection clip 601 inside the longitudinal cavity 401. In order to release the interconnection clip 601 and extricate it from the longitudinal cavity 401, the barb 901 must be depressed with a finger while pulling the interconnection clip 601 and the temple 102-L or 102-R apart. The semi-cylindrical 103 recess below the rectangular aperture 402, on the inner surface 403 of the temple 404-L or 404-R, facilitates depressing the barb 901 with the end of a finger. With a modicum of practice, the temples can be changed within ten seconds. For a preferred embodiment of the invention, multiple sets of distinctive temples are provided with each eyeglass frame so that they may be interchanged at will.

Although only a single embodiment of the new Eyeglass Frame Having Selectively Interchangeable Temples with Simplified Recessed Interconnection Clips has been shown and described, it will be obvious to those having ordinary skill in the art that changes and modifications may be made thereto without departing from the scope and the spirit of the invention as hereinafter claimed.

What is claimed is:

1. An eyeglass frame having temples which are quickly removable without the use of tools, said eyeglass frame comprising:
a frame front, said frame front having left and right end pieces, each end piece incorporating coaxial, spaced-apart, upper and lower butt hinge loops;
an interconnection clip for each end piece, each interconnection clip having a single butt hinge loop at a first end thereof that slides between the upper and lower butt hinge loops, said interconnection clip further having a single barb clip at a second end thereof opposite the single butt hinge loop;
a pivot screw that interconnects the upper and lower butt hinge loops with the single butt hinge loop of the interconnection clip to form a functional butt hinge with the pivot screw as the hinge pivot;
left and right temples, each temple having a longitudinal cavity of generally rectangular cross section, at the a hinge end thereof, that is in communication with a rectangular aperture that opens to an inner surface of the temple, wherein each temple is attachable to its respective interconnection clip by inserting said second end into the longitudinal cavity, thereby compressing the single barb until it reaches the rectangular aperture, whereupon it, at least partially, decompresses, thereby locking the interconnection clip to the temple; and
wherein in order to release the interconnection clip and extricate it from the longitudinal cavity, the barb must be depressed within the window while pulling the interconnection clip and the temple apart.

2. The eyeglass frame of claim 1, wherein multiple sets of distinctive temples are provided with the eyeglass frame so that they may be interchanged at will.

3. The eyeglass frame of claim 1, wherein each temple is equipped with a recess below the rectangular aperture on the inner surface of the temple, said recess facilitating depressing of the barb with the end of a finger.

4. An eyeglass frame having temples which are quickly removable without the use of tools, said eyeglass frame comprising:
a frame front, said frame front having left and right end pieces;
an interconnection clip having a first end hingeably connected to each end piece and a second which incorporates a single barb clip;
left and right temples, each temple having a longitudinal cavity of generally rectangular cross section, at the a hinge end thereof, that is in communication with a rectangular aperture that opens to an inner surface of the temple, wherein each temple is attachable to its respective interconnection clip by inserting said second end into the longitudinal cavity, thereby compressing the single barb until it reaches the rectangular aperture, whereupon it, at least partially, decompresses, thereby locking the interconnection clip to the temple; and
wherein in order to release the interconnection clip and extricate it from the longitudinal cavity, the barb must be depressed within the window while pulling the interconnection clip and the temple apart.

5. The eyeglass frame of claim 4, wherein multiple sets of distinctive temples are provided with the eyeglass frame so that they may be interchanged at will.

6. The eyeglass frame of claim 4, wherein each temple is equipped with a recess below the rectangular aperture on the inner surface of the temple, said recess facilitating depressing of the barb with the end of a finger.

7. An eyeglass frame having temples which are quickly removable without the use of tools, said eyeglass frame comprising:
a frame front, said frame front having left and right end pieces;
an interconnection clip having a first end hingeably connected to each end piece and a second which incorporates a single barb clip;
left and right temples, each temple having a longitudinal cavity at the a hinge end thereof, that is in communication with an aperture that opens to an inner surface of the temple, wherein each temple is attachable to its respective interconnection clip by inserting said second end into the longitudinal cavity, thereby compressing the single barb until it reaches the aperture, whereupon it decompresses and enters the window, thereby locking the interconnection clip to the temple; and
wherein in order to release the interconnection clip and extricate it from the longitudinal cavity, the barb must be depressed within the window while pulling the interconnection clip and the temple apart.

8. The eyeglass frame of claim 7, wherein multiple sets of distinctive temples are provided with the eyeglass frame so that they may be interchanged at will.

9. The eyeglass frame of claim 7, wherein each temple is equipped with a recess below the aperture on the inner surface of the temple, said recess facilitating depressing of the barb with the end of a finger.
